(19) United States
(12) Patent Application Publication
(10) Pub. No.: US 2002/0035021 A1
(43) Pub. Date: Mar. 21, 2002

(54) Method and an apparatus for inserting a fastener into a packing strip or plate

(76) Inventor: Thierry Birkel, Vandoeuvre Les Nancy (FR)

Correspondence Address: LOWE HAUPTMAN GOPSTEIN, GILMAN AND BERNER LLP, SUITE 310, 1700 DIAGONAL ROAD, ALEXANDRIA, VA, 22314

(21) Appl. No.: 09/950,921

(22) Filed: Sep. 13, 2001

(30) Foreign Application Priority Data
Sep. 14, 2000 (FR) 0011704

(51) Int. Cl. B31B 1/04

(52) U.S. Cl. 493/147

(57) ABSTRACT

The invention relates to a method and an apparatus for inserting a fastener (3) into a flexible plate or strip (1) which shall act as a packing structure and which comprises a channel fitted with two lips (2a, 2b) partly closing said channel, the fastener (3) to be inserted between said lips, said method being characterized in that it consists in slightly bending the plate or strip (1) transversely to the direction of its channel in a way to spread apart its lips (2a, 2b), furthermore to insert the fastener (3) and to substantially reflatten said plate or strip (1) in order that said lips (2a, 2b) shall resume their initial positions.

The invention relates to a method and to an apparatus for inserting a fastener into a flexible strip or plate that shall constitute a packing structure.

It is known, when packing, to gird the said packing structure—for instance a cardboard structure—with a hoop or the like, illustratively a plastic strip, in order to close or rigidify said packing structure.

This kind rigidification entails the difficulty that the packing structure must be held in place when being hooped and obviously both the packing structure and its hooping means must be handled simultaneously.

Accordingly the inventor conceived of a method and an apparatus for inserting such a fastener into a flexible plate or strip that shall constitute the packing structure and which is fitted with a channel comprising two lips that partly close said channel, said fastener being inserted between these two lips.

The method of the invention is characterized in that it slightly bends the plate or strip transversely to the channel direction in a way to move apart its lips, in inserting the fastener and in substantially flattening again said plate or strip in order that these lips resume their initial positions.

Moreover, in one embodiment of the present invention, the plate or strip is displaced longitudinally relative to its channel during the transverse bending and flattening operations while illustratively the plate or strip shall be guided before being bent by at least one means inserted into its channel.

The fastener also may be advantageously held in position against the bottom of the channel by depressing it during the re-flattening stage.

Preferably the channel lips shall be crushed after the plate or strip has been re-flattened.

Illustratively the fastener being used in the present invention is in the form of a hoop or the like, even though it also may be in other forms such as cables etc.

To carry out such a method, the invention also proposes an apparatus which is characterized in that it comprises a sub-assembly for slightly transversely bending the plate or strip, further an element inserting the fastener and a sub-assembly re-flattening the plate or strip, as well as elements driving the plate or strip in its channel's longitudinal direction.

In one embodiment mode of the invention, the bending sub-assembly consists of two superposed wheels of which the rims resp. are one substantially concave and one substantially convex surface, the plate or strip being made to pass through said wheels and its channel facing the concave-rim wheel.

In this embodiment, advantageously the element inserting the fastener consists of a guide ramp feeding said fastener, the end of said ramp extending as far as the vicinity of the bending wheels and between them, said fastener moreover being fitted with a circular rib on the concave wheel in order that the rib may press against the fastener during bending.

Preferably the strip re-flattening element comprises straightening fins which pass gradually from an oblique to a substantially plane position, and the apparatus of the invention also comprises a fastener holding-element configured above the straightening fins and optionally in the form of a small bar.

The apparatus of the invention also may comprise an initial holding and guiding element for the plate or strip, which is configured upstream of the bending subassembly as seen in the direction of motion of the plate or strip, and which is a cylinder on which moves said plate or strip, further comprising a roller that rests against the bottom of the channel in said plate or strip. Moreover an aligning guide in the form of a small bar may be configured between the initial holding and guiding element on one hand and the bending sub-assembly on the other.

Advantageously a sub-assembly crushing the channel lips and in the form of compression drums is configured downstream of the re-flattening element.

The elements driving the plate or strip in its longitudinal direction illustratively consist at least in part motors powering at least one of the bending sub-assembly wheels and/or the initial holding and guiding cylinder and/or at least one of the drums crushing the channel lips.

As regards a plate or strip which is additionally fitted with a substantially right-angle flange for the purpose of constituting a bracket, the apparatus of the invention also may be characterized in that the cylinder of the initial holding and guiding element and one of drums of the crushing sub-assembly do comprise a peripheral, circular channel to receive the substantially right-angle flange of the plate or strip.

The invention is elucidated in the description below which relates to the attached drawings:

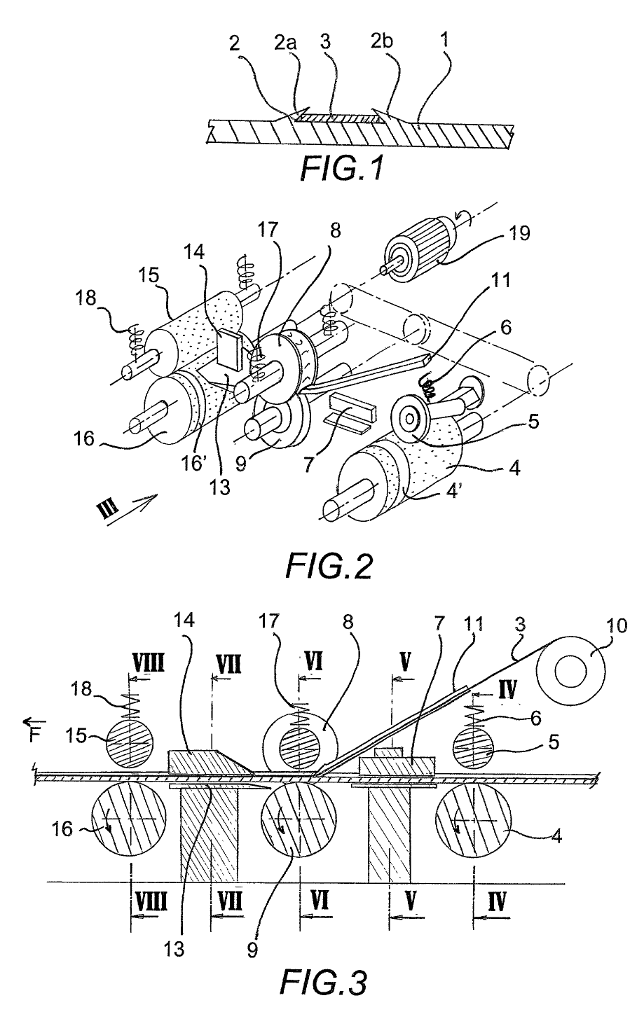

FIG. 1 shows a plate or strip with a hoop inserted into it by the apparatus of the invention,

FIG. 2 is a schematic perspective of an apparatus of the invention,

FIG. 3 is a longitudinal section of FIG. 2 along the arrow III and also shows the plate or strip to be processed,

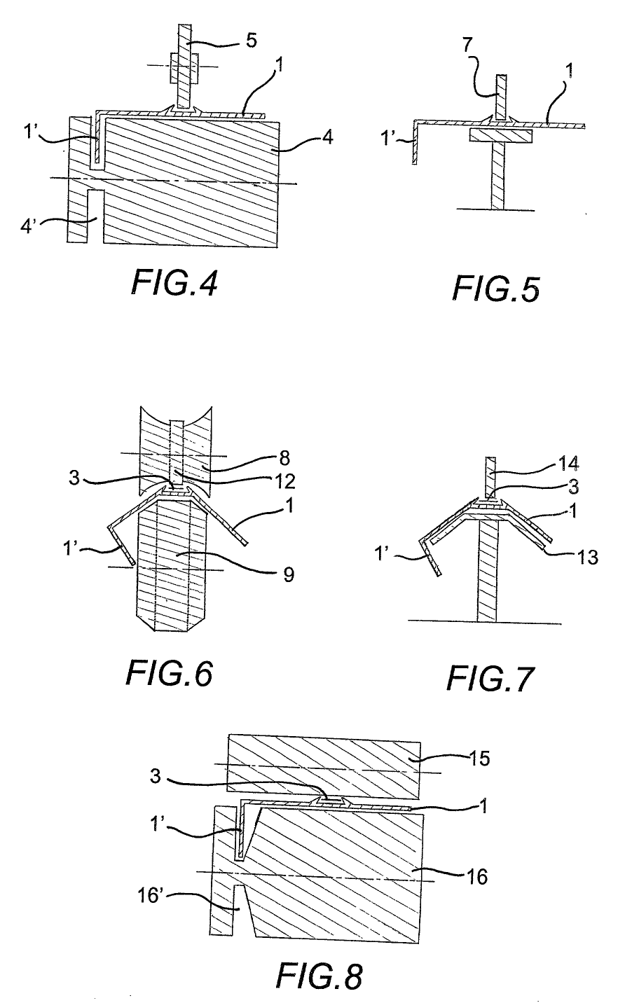

FIGS. 4-8 are sections resp. along IV-IV, V-V, VI-VI, VII-VII, VIII-VIII of FIG. 3.

FIG. 1 shows a flexible plate or strip 1 fitted with a shaped channel 2 comprising two lips 2a and 2b which partly close said channel 2, a hoop 3 or the like being inserted into this channel. The channel 2 runs straight and longitudinally.

To insert or crimp such a hoop, the invention therefore proposes bending the plate or strip 1 transversely to the direction of its channel 2, to insert the hoop 3 and to re-flatten said plate or strip.

For that purpose the invention proposes the shown apparatus which is displayed especially clearly in FIGS. 2 and 3 and which continuously inserts said fastener in the above described method and of which other features will be discussed below in the description of this apparatus of the invention.

The apparatus of the invention is fitted with an initial holding and guiding sub-assembly comprising a cylinder 4—in this instance it is motor driven as discussed farther below—and a freely rotating roller 5 which is illustratively stressed by a resilient means 6.

The strip 1 moves between the cylinder 4 and the roller 5 rolling inside the strip channel (FIG. 4).

For clarity's sake, the various components of FIGS. 3 through 8 are not shown being in contact with the strip 1.

An alignment guide in the form of a small bar 7 received in the channel 2 (FIG. 5) is configured downstream of the cylinder 4 as seen in relation to the strip's direction of advance shown by the arrow F (FIG. 3).

Downstream of the small bar 7, the apparatus of the invention is fitted with the sub-assembly bending the strip 1, in this instance in the form of two superposed wheels 8 and 9 between which passes said strip 1.

As shown in FIG. 6, the rims of the wheels 8 and 9 resp. exhibit a concave surface (wheel 8) and a substantially convex surface (wheel 9), the channel 2 of the strip 1 facing the concave wheel 8 in such a way that the strip 1 shall be slightly transversely bent as shown in this FIG. 6.

The hoop 3 is fed from a storage means, for instance a coil 10 (FIG. 3) along a guidance ramp 11 (FIGS. 2, 3) of which the end reaches the vicinity of the wheels 8 and 9, whereas said concave wheel 8 is fitted with a central and circular rib 12 (FIG. 6) to support the hoop 3 and to keep it in position in the channel 2.

An element re-flattening the strip 1 and in this instance in the form of straightening fins 13 (FIG. 7) is configured in the exit zone of the bending wheels 8 and 9, said fins progressively passing from an oblique position (relative to the horizontal) to a substantially plane position (FIG. 2).

An element in the form of a small bar 14 is configured above the straightening fins to keep the hoop 3 in position.

When leaving the straightening fins 13, the strip 1 therefore is flattened again and is made to pass between two compression drums 15, 16 (FIGS. 2, 3 and 8) to crush the assembly for the purpose of closing again the channel lips 2a and 2b on the hoop 3.

FIGS. 2 and 3 moreover show that the wheel 8 of the bending sub-assembly and the drum 15 of the crushing elements (such as the above described roller 5) are loaded in resilient manner schematically indicated in FIGS. 1 and 2 by. springs 17 and 18 resp.

In the embodiment illustrated in FIGS. 4 through 8, the plate or strip 1 is fitted with a substantially right-angle flange 1′ in order to constitute a right-angle bracket.

In this latter embodiment, the initial guiding cylinder 4 (FIGS. 2 and 4) and the crushing drum 16 (FIGS. 2 and 8) are fitted with peripheral and circular slots 4′ and 16′ resp. to accommodate the right-angle flange 1′ of the plate or strip 1.

Obviously means also are provided to drive the plate or strip 1, namely in this instance a schematically indicated drive motor 19 (FIG. 2) which drives into rotation the cylinder 4 (the roller 5 being idle) and/or at least one of the wheels 8 and 9 of the bending sub-assembly and/or at least one of the crushing drums 15, 16.

In the light of the above described apparatus of the invention, the working of said apparatus and consequently the method of the invention are easily understood.

The plate or strip 1 of FIG. 1, which in this instance is also fitted with a substantially right-angle flange 1′, is inserted between the cylinder 4 and the roller 5 and then is driven as elucidated above by the motor 19 (FIG. 2) in the direction of the arrow F (FIG. 3), the flange 1′ being received in the circular slot 4′.

After being guided by the alignment guide 7, the plate or strip 1 is slightly bent transversely (FIGS. 2, 3 and 6), while the hoop 3 is continuously deposited into the strip's or plate's channel 2 by means of the guide ramp 11.

The assembly is then re-flattened by the straightening fins 13 and the small support bar 14 (FIGS. 2, 3 and 7) before being made to pass between the crushing drums 15 and 16 of the lips 2a, 2b of the channel 2 (FIGS. 1, 2, 3 and 8), the flange 1′ being received in the slot 16′ of the drum 16.

Once fitted in this manner, the plate or strip 1 may then be used as any kind of packing structure that in this manner comprises an integrated fastener.

Using a strip in particular, a protective packing structure in the form of a collar to enclose at least part of a cylindrical object.

Illustratively the end of a pipe or tube may be protected by using a strip fitted with a substantially right-angle flange in the manner discussed above.

1. A method for inserting a fastener (3) into a flexible plate or strip (1) which shall constitute a packing structure and which is fitted with a channel (2) comprising two lips (2a, 2b) partially closing said channel, said fastener (3) to be inserted between said lips,
characterized in that this method consists in slightly bending the plate or strip (1) in the direction transverse to that of its channel (2) in a way to spread apart its lips (2a, 2b), to insert the fastener (3) and to substantially re-flatten said plate or strip (1) in order that said lips resume their initial positions.

2. Method as claimed in claim 1, characterized in that the plate or strip (1) furthermore is displaced in the longitudinal direction (F) at its channel (2) during the stages of transverse bending and of re-flattening.

3. Method as claimed in either of claims 1 and 2, characterized in that the plate or strip (1) previously to being bent shall by guided by at least one means inserted into its channel.

4. Method as claimed in one of claims 1 through 3, characterized in that the fastener (3) is kept against the bottom of the channel by pressing against said fastener during the re-flattening stage.

5. Method as claimed in one of claims 1 through 4, characterized in that, following re-flattening the plate or strip (1), the channel's lips (2a, 2b) will be crushed.

6. Method as claimed in one of claims 1 through 5, characterized in that the fastener being used is in the form of a hoop (3) or the like.

7. Apparatus with which to continuously insert a fastener (3) into a flexible plate or strip (1), said plate or strip being desired to constitute a packing structure and being fitted with a channel (2) comprising two lips (2a, 2b) which partly close this channel, said fastener (3) to be inserted between said lips, where said apparatus is
characterized in that it comprises a sub-assembly (8, 9) to slightly bend the strip or plate (1) transversely, further a sub-assembly (11, 12) inserting the fastener and means (15, 16) re-flattening the plate or strip (1), and means (19) to drive the plate or strip (1) at its channel (2) in the longitudinal direction.

8. Apparatus as claimed in claim 7, characterized in that the sub-assembly implementing slight bending consists of two superposed wheels (8, 9) of which the resp. rims exhibit one concave and one substantially convex surface, the plate or strip (1) being made to pass between said wheels and its channel (1) facing the concave-rim wheel (8).

9. Apparatus as claimed in claim 8, characterized in that the sub-assembly inserting the fastener (3) consists of a guide ramp (11) feeding said fastener, the end of said ramp reaching the vicinity of the bending wheels (8, 9) and being configured between them, and of a circular rib (12) on the concave wheel (8) in order that said rib (12) may press against the fastener (3) during bending.

10. Apparatus as claimed in one of claims 7 through 9, characterized in that the sub-assembly re-flattening the plate or strip (1) includes straightening fins (13) which gradually change from an oblique position to a substantially plane position.

11. Apparatus as claimed in claim 10, characterized in that it furthermore comprises a means to hold the fastener and configured above the straightening fins (13) and in the form of a small bar (14).

12. Apparatus as claimed in one of claims 7 through 11, characterized in that furthermore it comprises an initial holding and guiding element for the strip or plate (1) configured upstream of the bending sub-assembly as seen in the direction of displacement F of said plate or strip and in the form of a cylinder (4) on which runs said plate or strip, and of a roller (5) which shall press against the bottom of the channel (2) of said plate or strip (1).

13. Apparatus as claimed in claim 12, characterized in that an alignment guide in the form of a small bar (7) is configured between the initial holding and guiding element and the bending sub-assembly.

14. Apparatus as claimed in one of claims 7 through 13, characterized in that it furthermore comprises, in the form of crushing drums (15, 16) configured downstream of the re-flattening element, an element crushing the lips (2a, 2b) of the channel (2).

15. Apparatus as claimed in one of claims 8, 12 and 14, characterized in that the means driving the plate or strip (1) longitudinally at its channel (2) consist at least in part of motors (19) driving at least one of the wheels (9) of the bending sub-assembly and/or of the initial holding and guiding cylinder (4) and/or of at least one of the crushing drums (16) of the lips (2a, 2b) of the channel (2).

16. Apparatus as claimed by the set of claims 12 and 14 for a plate or strip (1) furthermore fitted with a substantially right-angle flange (1′) in order to constitute a bracket, characterized in that the cylinder (4) of the initial holding and guiding element and one of the drums (16) of the crushing element are fitted with a peripheral and circular slot (4′, 16′) to receive the substantially right-angle flange (1′) of the plate or strip (1).
